(19) United States
(12) Patent Application Publication
(10) Pub. No.: US 2008/0114828 A1
(43) Pub. Date: May 15, 2008

(54) Network System

(75) Inventor: Hiroshi YOSHIDA, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/938,498

(22) Filed: Nov. 12, 2007

(30) Foreign Application Priority Data
Nov. 14, 2006 (JP) 2006-307626

(51) Int. Cl. G06F 15/16

(52) U.S. Cl. 709/201

(57) ABSTRACT

Disclosed is a network system including: a remote control device, to which a piece of identification information is assigned, wherein the first electronic device includes a first transmission section to transmit the set data and identification information to the server device; the server device includes: a save section to save the received set data and the identification information; the second electronic device includes a set data request section to transmit a transmission request and the identification information to the server device; the server device includes: an authentication section to authenticate whether or not the transmitted identification information corresponds to the saved identification information, and a second transmission section to transmit the extracted set data corresponding to the authenticated identification information to the second electronic device; and the second electronic device includes: a storage control section to allow the set data storage section to store the received set data.

### BACKGROUND OF THE INVENTION

1. Field of the Invention

The present invention relates to a network system in which a plurality of electronic devices is connected to a network.

2. Description of Related Art

In recent years, a network system in which electronic devices, such as a television receiver or a refrigerator, are used by being connected to a network, such as a local area network (LAN) in home or the Internet, has been spread. By the system, various merits, such as exchanges of data between electronic devices, the share of a file, remote control from outside the home, and download of content, can be obtained.

For example, Japanese Patent Application Laid-Open Publication No. 2005-341008 discloses a digital broadcast receiving apparatus that judges whether audience data to be saved into a nonvolatile memory can be copied or not by judging a copy attribute descriptor added to the audience data based on a data broadcast, which audience data is to be stored in the nonvolatile memory, by a broadcaster as an identifier to identify the audience data to be able to be copied or not. By the broadcast receiving apparatus, it becomes possible to back up the audience data safely without causing wrong copying of the point of program linkage at the time of the backup of audience information and the like at the time of trouble, replacement by purchase, and the like.

Now, when an electronic device is replaced by purchase and a new electronic device is begun to be used, the setting operation of the new electronic device must be conventionally performed from the beginning thereof. Consequently, there has been a problem of taking a lot of trouble and being troublesome.

### SUMMARY OF THE INVENTION

It is an object of the present invention to improve the operationality of the setting operation of an electronic device by using a network in a network system in which a plurality of electronic devices is connected to a network.

According to a first aspect of the invention, a network system includes: a first electronic device; a second electronic device; a server device connected to the first electronic device and the second electronic device through a network; and a remote control device, to which a piece of identification information is assigned, the remote control device including a key input section to receive a key operation by a user, wherein the first electronic device and the second electronic device severally include a set data storage section to store set data pertaining to setting of the first and second electronic devices, wherein the first electronic device includes a first transmission section to associate the set data stored in the set data storage section of the first electronic device and the identification information assigned to the remote control device and to transmit the associated set data and the identification information to the server device through the network on the basis of the key operation of the key input section in the remote control device; the server device includes: a first reception section to receive the set data and the identification information, which have been transmitted from the first electronic device by the first transmission section, and a save section to save the set data and the identification information, which have been received by the first reception section, the set data and the identification information being associated with each other; the second electronic device includes: a power source on/off section to control on and off of a power source of the second electronic device on the basis of the key operation of the key input section in the remote control device, and a set data request section to associate a transmission request of the set data saved by the save section and the identification information assigned to the remote control device with each other to transmit the associated transmission request and the set data to the server device through the network in response to turning-on of the power source by the power source on/off section; the server device includes: an authentication section to authenticate whether or not the identification information transmitted from the second electronic device by the set data request section corresponds to the identification information saved in the save section, and a second transmission section to extract the set data corresponding to the identification information authenticated by the authentication section from the save section to transmit the extracted set data to the second electronic device; and the second electronic device includes: a second reception section to receive the set data transmitted from the server device by the second transmission section, and a storage control section to allow the set data storage section to store the set data received by the second reception section, the storage control section deleting the set data stored by the set data storage section in response to turning-off of the power source by the power source on/off section.

According to a second aspect of the invention, a network system includes: a first electronic device; a second electronic device; a server device connected to the first electronic device and the second electronic device through a network; and a remote control device, to which a piece of identification information is assigned, the remote control device including a key input section to receive a key operation by a user, wherein the first electronic device and the second electronic device severally include a set data storage section to store set data pertaining to setting of the first and second electronic devices, wherein the first electronic device includes a first transmission section to associate the set data stored in the set data storage section of the first electronic device and the identification information assigned to the remote control device and to transmit the associated set data and the identification information to the server device through the network on the basis of the key operation of the key input section in the remote control device; the server device includes: a first reception section to receive the set data and the identification information, which have been transmitted from the first electronic device by the first transmission section, and a save section to save the set data and the identification information, which have been received by the first reception section, the set data and the identification information being associated with each other; the second electronic device includes a set data request section to associate a transmission request of the set data saved by the save section and the identification information assigned to the remote control device with each other to transmit the associated transmission request and the set data to the server device through the network on the basis of the key operation of the key input section in the remote control device; the server device includes: an authentication section to authenticate whether or not the identification information transmitted from the second electronic device by the set data request section corresponds to the identification information saved in the save section, and a second transmission section to extract the set data corresponding to the identification information authenticated by the authentication section from the save section to transmit the extracted set data to the second electronic device; and the second electronic device includes: a second reception section to receive the set data transmitted from the server device by the second transmission section, and a storage control section to allow the set data storage section to store the set data received by the second reception section.

According to a third aspect of the invention, a network system includes: a first electronic device; a second electronic device; a server device connected to the first electronic device and the second electronic device through a network; and a plurality of remote control devices, to each of which a piece of identification information is assigned, each of the remote control devices including a key input section to receive a key operation by a user, wherein the first electronic device and the second electronic device severally include a set data storage section capable of individually storing set data pertaining to setting of the first and second electronic devices by the identification information assigned to each of the remote control devices, wherein the first electronic device includes a first transmission section to associate the set data stored in the set data storage section of the first electronic device and the identification information assigned to the remote control device and to transmit the associated set data and the identification information to the server device through the network on the basis of the key operation of the key input section in one of the remote control device; the server device includes: a first reception section to receive the set data and the identification information, which have been transmitted from the first electronic device by the first transmission section, and a save section to save the set data and the identification information, which have been received by the first reception section, the set data and the identification information being associated with each other; the second electronic device includes a set data request section to associate a transmission request of the set data saved by the save section and the identification information assigned to the remote control device with each other to transmit the associated transmission request and the set data to the server device through the network on the basis of the key operation of the key input section in the remote control device; the server device includes: an authentication section to authenticate whether or not the identification information transmitted from the second electronic device by the set data request section corresponds to the identification information saved in the save section, and a second transmission section to extract the set data corresponding to the identification information authenticated by the authentication section from the save section to transmit the extracted set data to the second electronic device; and the second electronic device includes: a second reception section to receive the set data transmitted from the server device by the second transmission section, a storage control section to allow the set data storage section to store the set data received by the second reception section, and a control section to perform predetermined control on the basis of the set data corresponding to the identification information assigned to the remote control device stored in the set data storage section in response to the key operation of the key input section in the remote control device.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating the whole configuration of the network system of a first embodiment;

FIG. 2 is a block diagram illustrating the configuration of the principal part of a remote control device;

FIG. 3 is a block diagram illustrating the configuration of the principal part of a first electronic device;

FIG. 4 is a block diagram illustrating the configuration of the principal part of a server device;

FIG. 5 is a diagram showing an example of a set data save table;

FIG. 6 is a block diagram illustrating the configuration of the principal part of a second electronic device provided in the network system of the first embodiment;

FIG. 7 is a flow chart illustrating set data transmission processing of the network system of the first embodiment;

FIG. 8 is a flow chart illustrating set data reception processing in the network system of the first embodiment;

FIG. 9 is a diagram illustrating the whole configuration of the network system of a second embodiment;

FIG. 10 is a block diagram illustrating the configuration of the principal part of a second electronic device provided in the network system of the second embodiment; and

FIG. 11 is a flow chart illustrating operation control processing in the network system of the second embodiment.

### DETAILED DESCRIPTION OF THE PREFERRED EMBODIMENTS

### First Embodiment

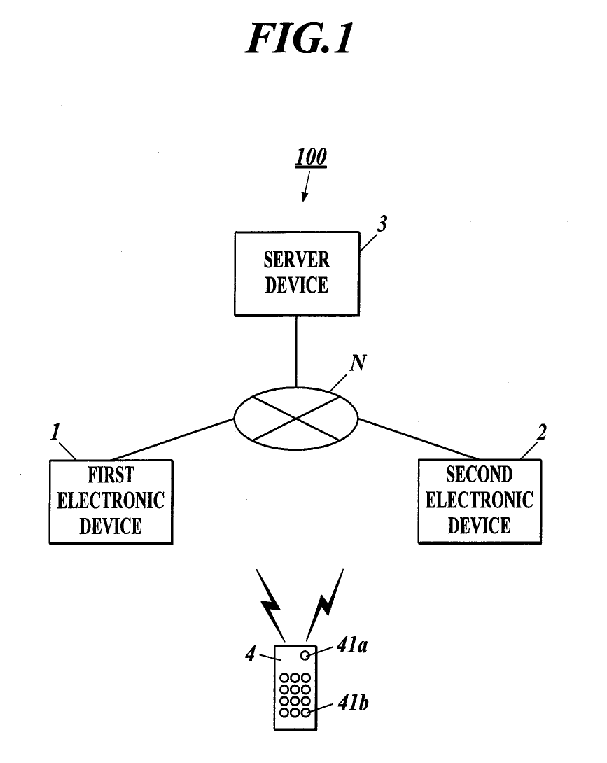

In the following, the network system of a first embodiment, to which the present invention is applied, is described in detail with reference to the attached FIGS. 1-7. Incidentally, the scope of the invention is not limited to the shown examples.

### <Configuration of Network System>

The configuration of a network system 100 of the present first embodiment is first described. FIG. 1 is a diagram illustrating the whole configuration of the network system 100 of the first embodiment.

In the network system 100 of the first embodiment, for example, as shown in FIG. 1, a first electronic device 1 and a second electronic device 2 are severally connected to a server device 3 through a network N. Each of the first electronic device 1 and the second electronic device 2 can be operated by a common remote control device 4. A user transmits various instructions to the first electronic device 1 or the second electronic device 2 with the remote control device 4 to perform the remote control of each of the electronic devices 1 and 2.

The network N is, for example, a communication network, such as the Internet, a local area network (LAN), or a wide area network (WAN), and includes various communication lines, such as a telephone network, an Integrated Services Digital Network (ISDN) network, a broad band communication network, a leased line, a mobile communication network, a communication satellite circuit, a community antenna television (CATV) network, an optical communication line, and a wireless communication line, and internet service providers connecting those various communication lines.

In the network system 100 of the present first embodiment, for example, when a user sets set data in the second electronic device 2, the user does not set the set data from the beginning in the second electronic device 2, but the user performs the following processing. That is, the user first operates the remote control device 4 to transmit preset set data in the first electronic device 1 to the server device 3 together with the identification information of the remote control device 4, and to save the set data received by the server device 3 in the server device 3 by associating the set data with the identification information of the remote control device 4. Furthermore, by an operation of the remote control device 4, to which the identification information used at the time of transmitting the set data of the first electronic device 1 to the server device 3 has been assigned, the second electronic device 2 transmits a transmission request of the set data to the server device 3, and the server device 3 performs the authentication based on the identification information of the remote control device 4 transmitted from the second electronic device 2 together with the transmission request. When the user has used the remote control device 4 that has been assigned the same identification information, the server device 3 considers that the authentication has been normally performed. Then, the set data saved in the server device 3 is transmitted to the second electronic device 2, and the set data received by the second electronic device 2 is stored therein. Consequently, because the second electronic device 2 can set the set data only by downloading the set data of the first electronic device 1 from the server device 3 through the network N by the use of the remote control device 4 to which the same identification information as that of the remote control device 4 used at the time of the transmission of the set data of the first electronic device 1 to the server device 3 is assigned, it becomes unnecessary for the second electronic device 2 to perform a setting operation from the beginning, and the improvement of the operationality of the setting operation of the electronic device can be achieved.

Moreover, the present first embodiment is configured so that, when the power source of the second electronic device 2 is turned on by the remote control device 4, to which one piece of identification information is assigned, the processing described above is executed and the set data corresponding to the remote control device 4 is automatically set in the second electronic device 2. Consequently, any special operations for setting the set data become unnecessary, and desired set data can be set only by using the corresponding remote control device 4. Thereby, the operationality can further be improved.

Furthermore, the first embodiment is configured so that, when the power source of the second electronic device 2 is turned off by an operation of the remote control device 4, to which the one piece of identification information is assigned, the set data set in the second electronic device 2 is automatically deleted. Consequently, it can be prevented that the set data is illegally used or changed by a third person.

### (Configuration of Remote Control Device)

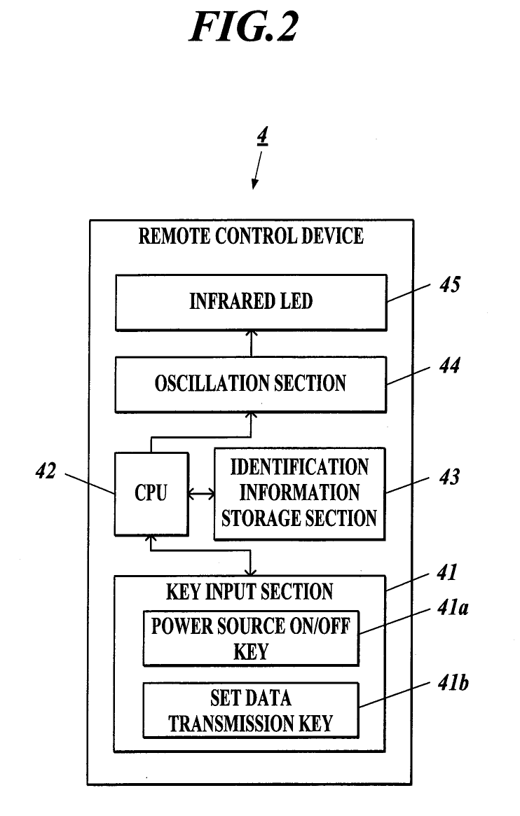

The remote control device 4 includes, for example, as shown in FIG. 2, a key input section 41 for receiving a key operation by a user, a central processing unit (CPU) 42 to perform various kinds of control in the remote control device 4, an identification information storage section 43, an oscillation section 44, and an infrared light emitting diode (LED) 45. The remote control device 4 then outputs a remote control signal corresponding to the key subjected to a depression operation. The remote control device 4 can cope with both of the first electronic device 1 and the second electronic device 2.

The key input section 41 includes, for example, a power source on/off key 41a for controlling on and off of the power source of the first electronic device 1 or the second electronic device 2, and a set data transmission key 41b for transmitting the set data set in an electronic device, such as the first electronic device 1, to the server device 3. Furthermore, the key input section 41 is provided with a menu key for displaying various menu screens, a cursor key for selecting a desired item, a channel key for selecting a channel, a volume up/down key for regulating sound volume, and the like, although they are not shown.

When a user performs an depression operation of a key equipped in the key input section 41 with the remote control device 4 directed toward the direction of the first electronic device 1 or the second electronic device 2, a remote control signal corresponding to the key depressed by the user is generated by the control of the CPU 42, and the generated remote control signal is output by the oscillation section 44, the infrared LED 45, and the like. Consequently, the remote control signal based on the depression operation by the user is output to the first electronic device 1 or the second electronic device 2.

To put it concretely, for example, if the user depresses the set data transmission key 41b of the key input section 41 with the remote control device 4 directed to the first electronic device 1, then a remote control signal that instructs the first electronic device 1 to transmit the set data set in the first electronic device 1 to the server device 3 is generated, and the generated remote control signal is output to the first electronic device 1. Moreover, for example, if the user depresses the power source on/off key 41a in the key input section 41 with the remote control device 4 directed to the second electronic device 2, then a remote control signal that instructs the second electronic device 2 to perform the on/off of the power source thereof is generated, and the generated remote control signal is output to the second electronic device 2.

The identification information storage section 43 is, for example, a nonvolatile memory, such as an electrically erasable programmable read only memory (EEPROM) or a flash memory, and stores one piece of identification information (for example, “001”) assigned to the remote control device 4. The identification information is included in a part (for example, custom code) of the remote control signal to be generated on the basis of the depression operation of a key in the key input section 41 mentioned above. The identification information included in the remote control signal generated on the basis of the depression operation of the key input section 41 is used for the electronic device received the remote control signal to identify whether the remote control signal is an instruction for itself or not. Moreover, at the time of the execution of a first transmission program 163a (which will be described later) in the first electronic device 1 or the execution of a set data request program 263b (which will be described later) in the second electronic device 2, the identification information is extracted from the remote control signal received by the first electronic device 1 or the second electronic device 2 to be transmitted to the server device 3.

### (Configuration of First Electronic Device)

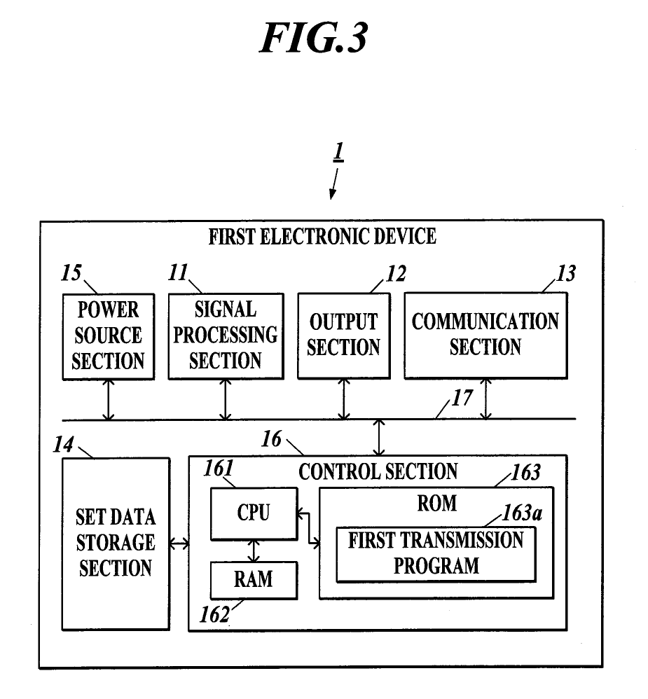

The first electronic device 1 is, for example, a television receiver, and is connected to the server device 3 through the network N. FIG. 3 is a block diagram illustrating the configuration of the principal part of the first electronic device 1.

To put it concretely, the first electronic device 1 includes, for example, as shown in FIG. 3, a signal processing section 11 to perform various kinds of image and sound processing based on television broadcast signals, an output section 12 to output an image and an sound based on an image signal and a sound signal, respectively, output from the signal processing section 11, a communication section 13 to perform the transmission and the reception of information with the server device 3 through the network N, a set data storage section 14 as a set data storage section to store set data of the first electronic device 1, a power source section 15 to perform the supply of electric power, and a control section 16. Each section is connected to one another through a bus 17.

The signal processing section 11 performs predetermined image and sound processing to image and sound signals, such as a television broadcast signal, which signals have been input from a not-shown antenna, an input terminal, or the like, and outputs the processed signals to the subsequent stage output section 12.

The output section 12 includes a not-shown display section and a speaker device. The output section 12 makes the display section display the image based on an image signal output from the signal processing section 11, and makes the speaker device output the sound based on a sound signal output from the signal processing section 11 therefrom.

The communication section 13 performs the transmission and the reception of information with the server device 3 connected to the network N, such as the Internet, through the network N.

The set data storage section 14 is, for example, a nonvolatile memory, such as an electrically erasable programmable ROM (EEPROM) or a flash memory, and stores set data set by a user. The set data is various kinds of user data, such as the personal information of the user, such as the name, the address, the telephone number, and the like, of the user, which has been input on the setting screen or the like, customizing data, application software that the user has installed, and the like.

The power source section 15 converts an alternating voltage supplied from, for example, a commercial alternating-current power supply through a not-shown power cord into direct-current voltages VCC and VDD of predetermined voltage values, and outputs the converted direct-current voltages VCC and VDD to the control section 16.

The control section 16 is composed of, for example, a CPU 161, a random access memory (RAM) 162, and a read only memory (ROM) 163.

The CPU 161 executes various kinds of control processing in accordance with the processing programs stored in the ROM 163.

The ROM 163 stores the system program that can be executed in the first electronic device 1, the various processing programs that can be executed on the system program, the data to be sued at the time of the execution of these various processing programs, the data of the processing results of arithmetic processing of the CPU 161, and the like. The programs are stored in the form of the program codes that a computer can read.

To put it concretely, the ROM 163 includes, for example, the first transmission program 163a.

The first transmission program 163a is a program for enabling the CPU 161 to realize, for example, the function of associating the set data stored in the set data storage section 14 of the first electronic device 1 and the identification information assigned to the remote control device 4 with each other to transmit the associated set data and the identification information to the server device 3 through the network N on the basis of a key operation of the key input section 41 in the remote control device 4.

To put it concretely, when a user performs a depression operation of the set data transmission key 41b in the key input section 41 of the remote control device 4 and a remote control signal instructing the first electronic device 1 to transmit the set data set in the first electronic device 1 to the server device 3 is output to the CPU 161, the CPU 161 reads the set data stored in the set data storage section 14, and reads the identification information (for example, “001”) of the remote control device 4 included in the remote control signal transmitted from the remote control device 4. The CPU 161 then associates the read set data and the read identification information with each other to transmit them to the server device 3 through the network N with the communication section 13.

The CPU 161 functions as a first transmission section by executing such first transmission program 163a.

### (Configuration of Server Device)

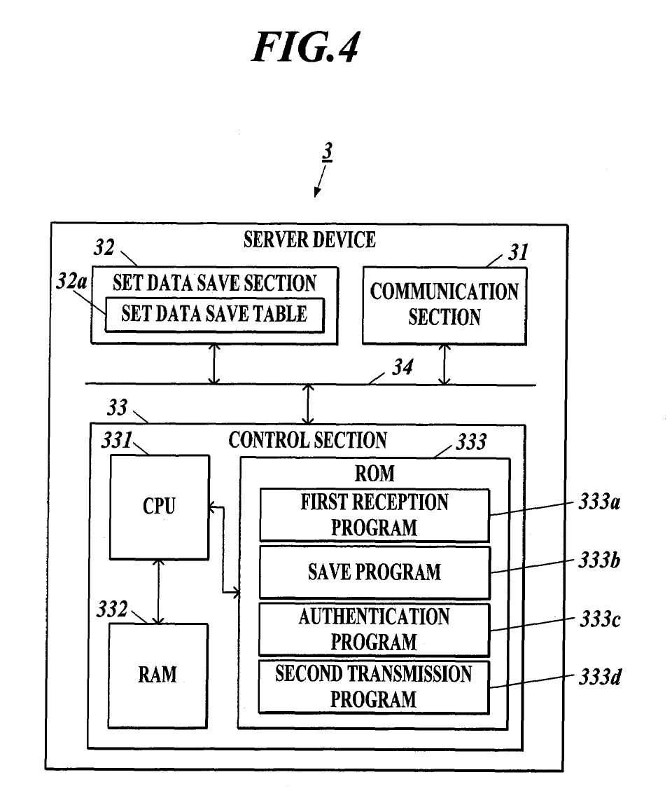

The server device 3 is connected to the first electronic device 1 and the second electronic device 2 through the network N, such as the Internet. FIG. 4 is a block diagram illustrating the configuration of the principal part of the server device 3.

To put it concretely, the server device 3 includes, for example, as shown in FIG. 4, a communication section 31 a set data save section 32, and a control section 33. Each section is connected to one another through a bus 34.

The communication section 31 performs the transmission and the reception of information with the first electronic device 1 or the second electronic device 2, both of which are connected to the network N, through the network N, such as the Internet.

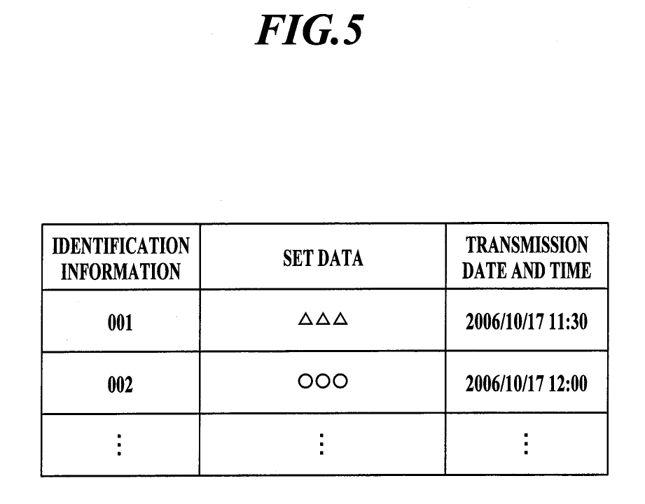

The set data save section 32 is composed of, for example, a nonvolatile memory, such as an EEPROM and a flash memory, and includes a set data save table 32a (save section) to store the set data and the identification information that have been transmitted from the first electronic device 1, which set data and identification information have been received by the execution of a first reception program 333a, which will be described later, with the set data and the identification information associated with each other. FIG. 5 is a diagram showing an example of the set data save table 32a.

The set data save table 32a stores, for example, as shown in FIG. 5, the set data, and the transmission date and time of the set data, which are associated with the set data, by the identification information of remote control devices 4. In the set data save table 32a, old data is deleted to be updated to new set data every transmission of set data from the remote control device 4.

The control section 33 is composed of, for example, a CPU 331, a RAM 332, and a ROM 333.

The CPU 331 executes various kinds of control processing in accordance with the processing programs stored in the ROM 333.

The RAM 332 includes a program storage region for expanding a processing program and the like that are executed by the CPU 331, a data storage region for storing input data and a processing result to be produced at the time of the execution of the processing program, and the like.

The ROM 333 stores the system program that can be executed in the server device 3, the various processing programs that can be executed on the system program, the data to be used at the time of the execution of these various processing programs, the data of the processing results of arithmetic processing of the CPU 331, and the like. The programs are stored in the form of the program codes that can be read by a computer.

To put it concretely, the ROM 333 includes, for example, the first reception program 333a, a save program 333b, an authentication program 333c, and a second transmission program 333d.

The first reception program 333a is a program for enabling the CPU 331 to realize, for example, the function of receiving the set data and the identification information that have been transmitted from the first electronic device 1 by the execution of the first transmission program 163a in the first electronic device 1.

To put it concretely, when the set data stored in the set data storage section 14 of the first electronic device 1 and the identification information of the remote control device 4 by which the key operation for transmitting the set data has been performed are transmitted from the first electronic device 1 through the network N, such as the Internet, the CPU 331 receives the set data and the identification information with the communication section 31.

The CPU 331 functions as a first reception section by executing such first reception program 333a.

The save program 333b is a program for enabling the CPU 331 to realize, for example, the function of saving the set data and the identification information, which have been received by the execution of the first reception program 333a, with the set data and the identification information associated with each other.

To put it concretely, when the CPU 331 receives the set data and the identification information (for example, “001”) that have been transmitted from the first electronic device 1 with the communication section 31 by the execution of the first reception program 333a, the CPU 331 associates the set data and the identification information with each other to save them in the set data save table 32a.

The CPU 331 functions as a save section by executing such save program 333b.

The authentication program 333c is a program for enabling the CPU 331 to realize, for example, the function of performing the authentication of the identification information transmitted from the second electronic device 2 in the execution of the set data request program 263b (which will be described later) in the second electronic device 2 by judging whether the identification information corresponds to the identification information stored in the set data save table 32a or not.

To put it concretely, when the CPU 331 receives a transmission request to request the server device 3 to transmit the set data corresponding to the remote control device 4, which transmission request has been transmitted from second electronic device 2, and the identification information assigned to the remote control device 4 with the communication section 31, the CPU 331 executes the authentication processing to judge whether the received identification information (for example, “001”) is stored in the set data save table 32a or not. In the authentication processing, if the identification information transmitted from the second electronic device 2 corresponds to the identification information stored in the set data save table 32a, then the CPU 331 judges that the authentication has been performed normally. On the other hand, if the identification information transmitted from the second electronic device 2 does not correspond to the identification information stored in the set data save table 32a, then the CPU 331 judges that the authentication has not been performed normally.

The CPU 331 functions as an authentication section by executing such authentication program 333c.

The second transmission program 333d is a program for enabling the CPU 331 to realize, for example, the function of extracting the set data corresponding to the identification information authenticated by the execution of the authentication program 333c from the set data save table 32a to transmit the extracted set data to the second electronic device 2.

To put it concretely, if the identification information transmitted from the second electronic device 2 exists in the set data save table 32a and the authentication has normally been executed in the execution of the authentication program 333c mentioned above, then the CPU 331 extracts the set data saved in the state of being associated with the identification information from the set data save table 32a to transmit the extracted set data to the second electronic device 2, which has performed the transmission request of the set data, through the network N, such as the Internet, with the communication section 31.

The CPU 331 functions as a second transmission section by executing such second transmission program 333d.

### (Configuration of Second Electronic Device)

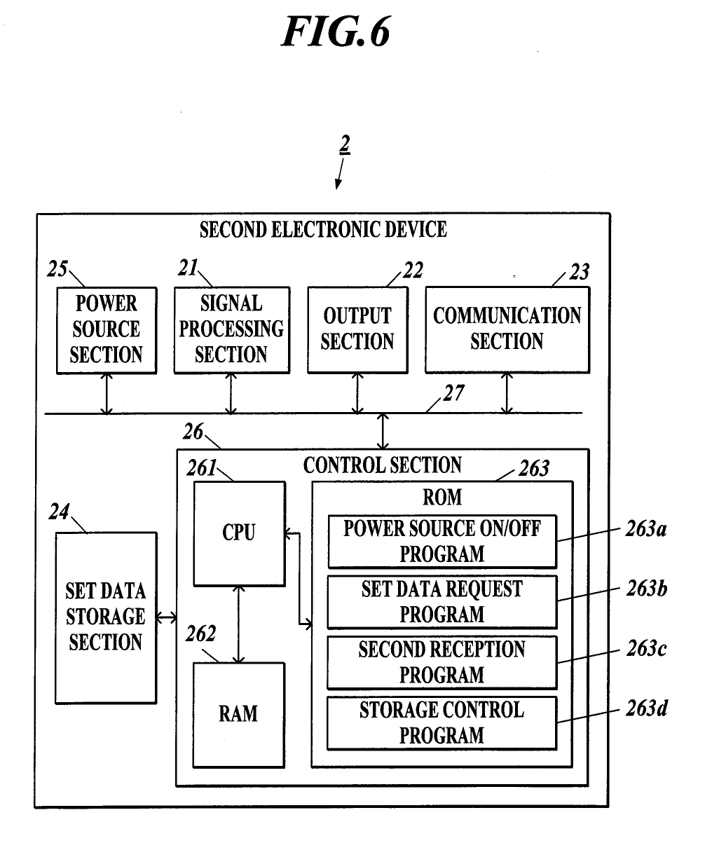

The second electronic device 2 is, for example, a television receiver, and is connected to the server device 3 through the network N, such as the Internet. FIG. 6 is a block diagram illustrating the configuration of the principal part of the second electronic device 2.

To put it concretely, the second electronic device 2 includes, for example, as shown in FIG. 6, a signal processing section 21 to perform various kinds of image and sound processing based on television broadcast signals, an output section 22 to output an image and a sound based on an image signal and sound signal, respectively, which are output from the signal processing section 21, a communication section 23 for performing the transmission and the reception of information with the server device 3 through the network N, a set data storage section 24 to store the set data of the second electronic device 2, a power source section 25 to perform the supply of electric power, and a control section 26. Each section is connected to one another through a bus 27.

The signal processing section 21 performs predetermined image and sound processing to image and sound signals, such as a television broadcast signal input from a not-shown antenna, an input terminal, or the like, and outputs the processed image and sound signals to the output section 22 at the subsequent stage.

The output section 22 includes a not-shown display section and a speaker device. The output section 22 makes the display section display an image based on an image signal output from the signal processing section 21, and makes the speaker device output a sound based on a sound signal output from the signal processing section 21.

The communication section 23 performs the transmission and the reception of information with the server device 3 connected to the network N, such as the Internet, through the network N.

The set data storage section 24 is configured similarly to, for example, the set data storage section 24 of the first electronic device 1, and is a nonvolatile memory, such as an EEPROM or a flash memory, to store set data. To put it concretely, the set data storage section 24 is a region for storing the set data transmitted from the server device 3 by the execution of a storage control program 263d, which will be described later.

The power source section 25, for example, converts an alternating voltage supplied from the commercial alternating-current power supply through a not-shown power cord into the direct-current voltages VCC and VDD of predetermined voltage values, and outputs the converted direct-current voltages VCC and VDD to the control section 26.

The control section 26 is composed of, for example, a CPU 261, a RAM 262, and a ROM 263.

The CPU 261 executes various kinds of control processing in accordance with processing programs stored in the ROM 263.

The RAM 262 includes a program storage region for expanding a processing program and the like to be executed by the CPU 261, a data storage region to store input data and processing results to be produced at the time of the execution of the processing program, and the like.

The ROM 263 stores the system program that can be executed in the second electronic device 2, the various processing programs that can be executed on the system program, the data to be used at the time of the execution of these various processing programs, the data of the processing results of arithmetic processing of the CPU 261, and the like. The programs are stored in the form of the program codes that a computer can read.

To put it concretely, the ROM 263 stores, for example, a power source on/off program 263a, the set data request program 263b, a second reception program 263c, and the storage control program 263d.

The power source on/off program 263a is a program for enabling the CPU 261 to realize, for example, the function of controlling on and off of the power source of the second electronic device 2 on the basis of a key operation of the key input section 41 in the remote control device 4.

To put it concretely, when a user performs an depression operation of the power source on/off key 41a in the key input section 41 of the remote control device 4 and a remote control signal instructing the turning on/off of the power source is output to the CPU 261, the CPU 261 outputs a control signal to instruct the turning-on of the power source or the turning-off of the power source to the power source section 25. When the power source section 25 receives the control signal instructing the turning-on of the power source from the CPU 261, the power source section 25 enables the supply of the electric power from the commercial alternating-current power supply, and moves to the power-on state thereof to perform the supply of the electric power to each section of the second electronic device 2. When the power source section 25 receives the control signal instructing the turning-off of the power source from the CPU 261, the power source section 25 disables the supply of the electric power from the commercial alternating-current power supply, and moves to the power-off state thereof to break the supply of the electric power to each section of the second electronic device 2.

The CPU 261 functions as a power source on/off section by executing such power source on/off program 263a.

The set data request program 263b is a program for enabling the CPU 261 to realize, for example, the function of transmitting a transmission request of the set data saved in the set data save table 32a of the server device 3 and the identification information assigned to the remote control device 4 to the server device 3 through the network N, such as the Internet, with the transmission request and the identification information associated with each other, in response to the turning-on of the power source by the execution of the power source on/off program 263a.

To put it concretely, when a user performs a depression operation of the power source on/off key 41a in the key input section 41 of the remote control device 4 and a remote control signal instructing the turning-on of the power source is output to the CPU 261 in the state of the power source of the second electronic device 2 being off, the CPU 261 moves to the state of being power-on thereof by the execution of the power source on/off program 263a before the CPU 261 reads the identification information of the remote control device 4 included in the remote control signal transmitted from the remote control device 4 to transmit a transmission request requesting the server device 3 to transmit the set data corresponding to the remote control device 4 among the pieces of set data saved in the set data save table 32a of the server device 3 and the identification information read from the remote control signal transmitted from the remote control device 4 to the server device 3 through the network N, such as the Internet, with the communication section 23, with the transmission request and the identification information associated with each other.

The CPU 261 functions as the power source on/off section by executing such set data request program 263b.

The second reception program 263c is a program for enabling the CPU 261 to realize, for example, the function of receiving the set data transmitted from the server device 3 by the execution of the second transmission program 333d of the server device 3.

To put it concretely, when the set data associated with the identification information of the remote control device 4 extracted from the set data save table 32a is transmitted from the second electronic device 2 to the CPU 261 through the network N, such as the Internet, by the execution of the second transmission program 333d of the server device 3 in response to the transmission request of the set data by the execution of the set data request program 263b, the CPU 261 receives the set data with the communication section 23.

The CPU 261 functions as a second reception section by executing such second reception program 263c.

The storage control program 263d is a program for enabling the CPU 261 to realize, for example, the function of storing the set data received by the execution of the second reception program 263c into the set data save table 32a and of deleting the set data stored by the set data save table 32a in response to the turning-off of the power source by the execution of the power source on/off program 263a.

To put it concretely, when the CPU 261 receives the set data transmitted from the second electronic device 2 with the communication section 23 by the execution of the second reception program 263c, the CPU 261 stores the set data into the set data storage section 24.

Moreover, when a user performs a depression operation of the power source on/off key 41a in the key input section 41 of the remote control device 4 and a remote control signal instructing the second electronic device 2 to turn off the power source thereof is output to the CPU 261 in the state of the turning-on of the power source of the second electronic device 2, the CPU 261 deletes the set data stored in the set data save table 32a, and then moves to the power-off state thereof by the execution of the power source on/off program 263a.

The CPU 261 functions as a storage control section by executing such storage control program 263d.

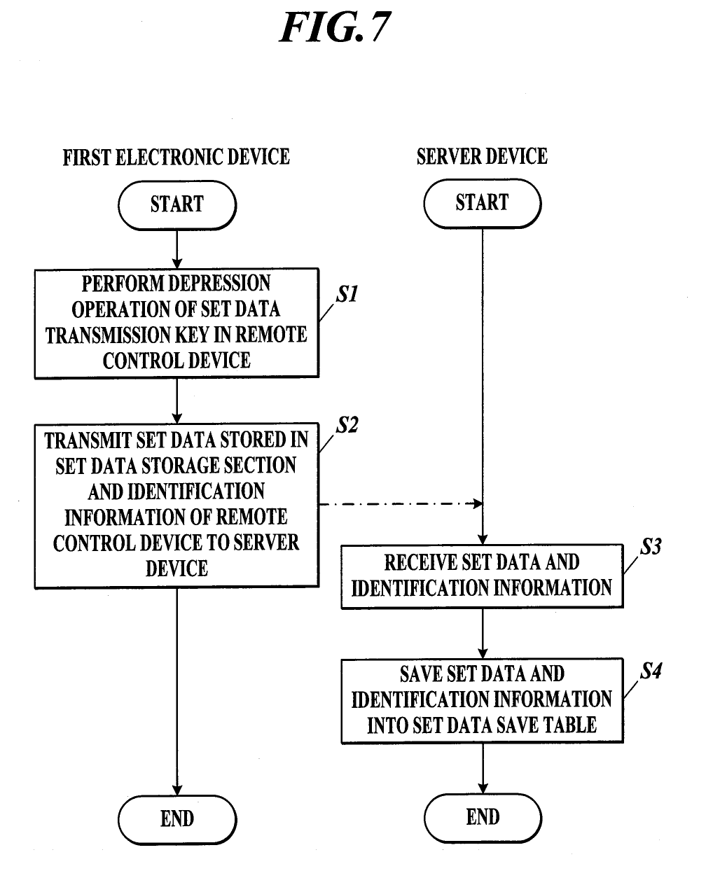

Next, set data transmission processing executed between the first electronic device 1 and the server device 3 is described with reference to the flow chart of FIG. 7.

The present set data transmission processing is performed by the execution of the first transmission program 163a by the CPU 161 in the first electronic device 1 and by the execution of the first reception program 333a and the save program 333b by the CPU 331 in the server device 3.

First, at Step S1, when a user performs a depression operation of the set data transmission key 41b provided in the key input section 41 with the remote control device 4 directed to the first electronic device 1, and when a remote control signal corresponding to the set data transmission key 41b is transmitted to the first electronic device 1, the CPU 161 of the first electronic device 1 transmits the set data stored in the set data storage section 14 and the identification information assigned to the remote control device 4 which identification information has been read from the remote control signal of the remote control device 4 to the server device 3 through the network N with the communication section 13 with the set data and the identification information associated with each other at Step S2, and then the CPU 161 ends the present processing.

At Step S3, when the CPU 331 of the server device 3 receives the set data and the identification information of the remote control device 4, which have been transmitted from the first electronic device 1 through the network N, with the communication section 31, the CPU 331 saves the received set data and the identification information of the remote control device 4 into the set data save table 32a with the set data and the identification information associated with each other at Step S4, and ends the present processing.

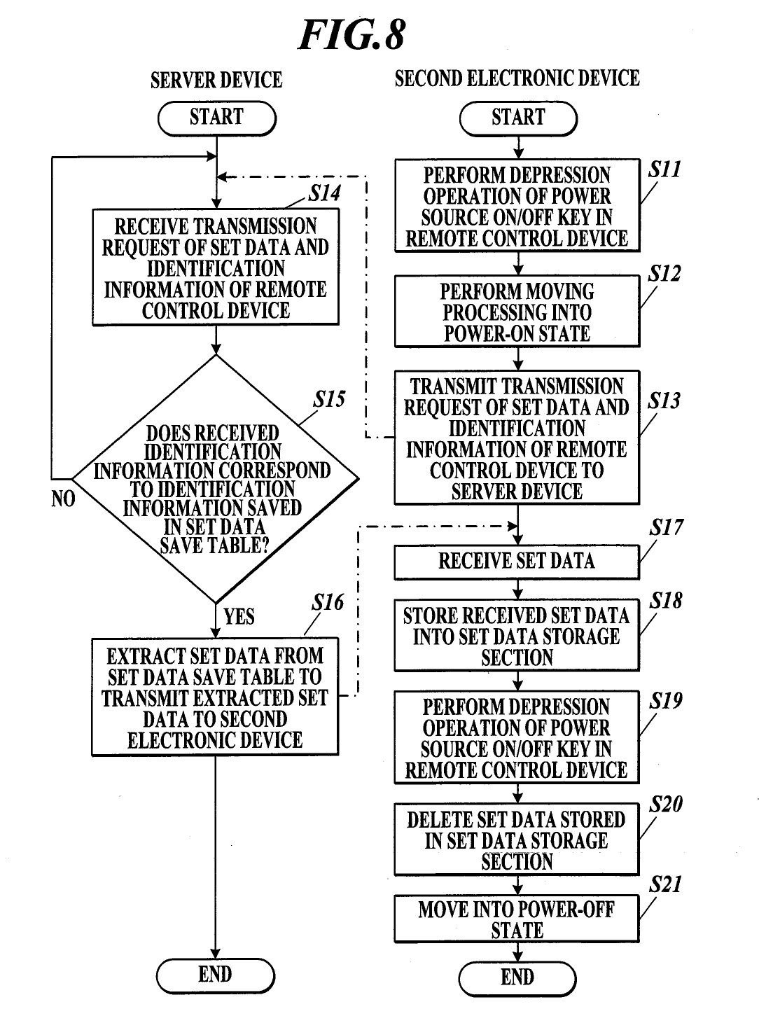

Next, set data reception processing executed between the second electronic device 2 and the server device 3 is described with reference to the flow chart of FIG. 8.

The present set data reception processing is performed by the execution of the set data request program 263b, the second reception program 263c, and the storage control program 263d by the CPU 261 in the second electronic device 2, in which the set data transmitted from the first electronic device 1 by the key operation in the remote control device 4 is stored in the state of being associated with the identification information of the remote control device 4 by the set data transmission processing mentioned above, and by the execution of the authentication program 333c and the second transmission program 333d by the CPU 331 in the server device 3.

First, at Step S11, when a user performs a depression operation of the power source on/off key 41a provided in the key input section 41 with the remote control device 4 directed to the second electronic device 2 in the power-off state thereof, and when a remote control signal corresponding to the power source on/off key 41a is transmitted to the second electronic device 2, the CPU 261 of the second electronic device 2 performs the processing of moving into the power-on state thereof at Step S12, and then the CPU 261 transmits a transmission request requesting the server device 3 to transmit the set data stored in the server device 3 and the identification information assigned to the remote control device 4, which identification information has been read from the remote control signal of the remote control device 4, to the server device 3 through the network N with the communication section 23 with the transmission request and the identification information associated with each other at Step S131.

At Step S14, when the CPU 331 of the server device 3 receives the transmission request of the set data and the identification information of the remote control device 4, which have been transmitted from the second electronic device 2 through the network N, with the communication section 31, the CPU 331 performs the authentication processing of the received identification information by judging whether the identification information corresponds to the identification information stored in the set data save table 32a or not at Step S15. When the CPU 331 of the server device 3 judges at the Step S15 that the identification information transmitted from the second electronic device 2 does not correspond to the identification information stored in the set data save table 32a (Step S15; No), the CPU 331 returns its processing to the Step S14 to repeat the above processing. On the other hand, when the CPU 331 judges at the Step S15 that the identification information transmitted from the second electronic device 2 corresponds to the identification information stored in the set data save table 32a (Step S15; Yes), the CPU 331 considers that the authentication has normally been performed, and extracts from the set data save table 32a the set data saved in the state of being associated with the identification information transmitted from the second electronic device 2 to transmit the extracted set data to the second electronic device 2 through the network N with the communication section 31 at Step S16. Then, the CPU 331 ends the present processing.

At Step S17, when the CPU 261 of the second electronic device 2 receives the set data transmitted from the server device 3 through the network N with the communication section 23, the CPU 261 stores the received set data into the set data storage section 24 at Step S18.

Furthermore, at Step S19, when a user performs a depression operation of the power source on/off key 41a provided in the key input section 41 with the remote control device 4 directed to the second electronic device 2 and a remote control signal corresponding to the power source on/off key 41a is transmitted to the second electronic device 2, the CPU 261 of the second electronic device 2 deletes the set data stored in the set data storage section 24 at Step S20, and then the CPU 261 moves to the power-off state thereof at Step S21. Then the CPU 261 ends the present processing.

According to the network system 100 of the above-mentioned first embodiment, to which the present invention is applied, one piece of identification information is assigned to the remote control device 4, and the remote control device 4 is provided with the key input section 41 to receive a key operation by a user. In the first electronic device 1 and the second electronic device 2, the set data storage sections 14 and 24 store set data pertaining to the setting of the electronic devices 1 and 2, respectively. In the first electronic device 1, the set data stored in the set data storage section 14 of the first electronic device 1 and the identification information assigned to the remote control device 4 are associated with each other, and the associated set data and the identification information are transmitted to the server device 3 through the network N by the execution of the first transmission program 163a by the CPU 161 on the basis of a key operation of the key input section 41 in the remote control device 4. In the server device 3, the set data and the identification information, which have been transmitted from the first electronic device 1, are received by the execution of the first transmission program 163a by the execution of the first reception program 333a by the CPU 331, and the set data and the identification information, which have been received by the execution of the first reception program 333a, are saved in the set data save table 32a with the set data and the identification information associated with each other by the execution of the save program 333b. Moreover, in the second electronic device 2, the power source thereof is turned on or off on the basis of a key operation of the key input section 41 in the remote control device 4 by the execution of the power source on/off program 263a by the CPU 261, and a transmission request of the set data saved by the execution of the save program 333b and the identification information assigned to the remote control device 4 are associated with each other and are transmitted to the server device 3 through the network N by the execution of the set data request program 263b in response to the turning-on of the power source of the second electronic device 2 by the execution of the power source on/off program 263a. In the server device 3, the authentication of the identification information transmitted from the second electronic device 2 by the execution of the set data request program 263b is performed by judging whether the identification information corresponds to the identification information saved in the set data save table 32a or not by the execution of the authentication program 333c by the CPU 331, and the set data corresponding to the identification information authenticated by the execution of the authentication program 333c is extracted from the set data save table 32a and is transmitted to the second electronic device 2 by the execution of the second transmission program 333d. Furthermore, in the second electronic device 2, the set data transmitted from the server device 3 is received by the execution of the second transmission program 333d by the CPU 261, and the set data received by the execution of the second reception program 263c is stored in the set data storage section 24 and the set data stored in the set data storage section 24 is deleted in response to the turn-off of the power source by the power source on/off program 263a by the execution of the storage control program 263d.

Consequently, because set data is set in the second electronic device 2 only by downloading the set data of the first electronic device 1 from the server device 3 through the network N by the use of the remote control device 4, to which the same identification information as that of the remote control device 4 used at the time of the transmission of the set data of the first electronic device 1 to the server device 3 is assigned, it becomes unnecessary to perform a setting operation from the beginning. Consequently, in the network system 100, in which the plurality of electronic devices is connected to the network N, the operationality in the setting operation of the electronic device can be improved.

Moreover, the second electronic device 2 is designed so that, when the power source of the second electronic device 2 is turned on by the remote control device 4, to which a piece of identification information is assigned, the set data corresponding to the remote control device 4 is automatically set in the second electronic device 2. Consequently, the performance of any special operations for setting the set data becomes unnecessary, and desired set data can be set only by using the correspond remote control device 4. Hence, the operationality can furthermore be improved. Moreover, the second electronic device 2 is designed so that, when the power source thereof is turned off by the one remote control device 4, the set data set in the second electronic device 2 is automatically deleted. Consequently, it can be prevented that the set data is illegally used or changed by a third person.

### Second Embodiment

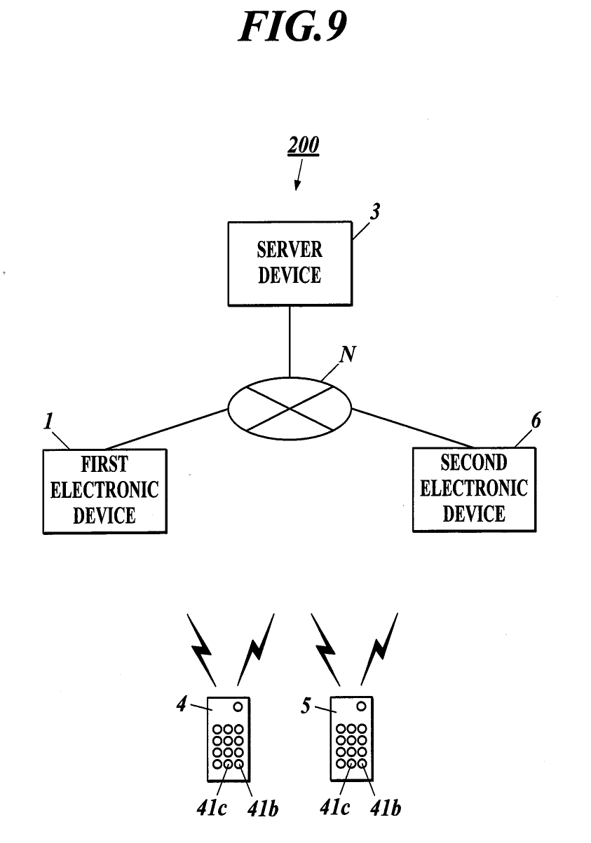

Next, the network system of a second embodiment, to which the present invention is applied, is described in detail with reference to FIGS. 9-11. Incidentally, the scope of the invention is not limited to the shown examples. Moreover, the same parts as those of the first embodiment are denoted by the same reference marks, and their descriptions are omitted.

### <Configuration of Network System>

First, the configuration of a network system 200 of the present second embodiment is described. FIG. 9 is a diagram illustrating the whole configuration of the network system 200 of the second embodiment.

In the network system 200 of the second embodiment, for example, as shown in FIG. 9, the first electronic device 1 and a second electronic device 6 are severally connected to the server device 3 through the network N. The first electronic device 1 and the second electronic device 6 can be operated by a plurality of common remote control devices 4 and 5 provided to the network system 200. A user transmits various instructions to the first electronic device 1 or the second electronic device 6 with either of the plurality of remote control devices 4 and 5 to perform the remote control of each of the electronic devices 1 and 6.

In the network system 200 of the present second embodiment, for example, similarly to the network system 100 of the first embodiment, the set data of the first electronic device 1 associated with the used remote control device 4 or 5 is set in the second electronic device 6 only by downloading the set data of the first electronic device 1 from the server device 3 through the network N by the use of the remote control device 4 or 5, to which the same identification information as that of the remote control device 4 or 5 used at the time of transmitting the set data of the first electronic device 1 to the server device 3 is assigned. Consequently, it becomes unnecessary to perform a setting operation from the beginning. Hence, in the network system 200, in which the plurality of electronic devices 1 and 6 is connected to the network N, the operationality in the setting operation of the electronic device can be improved.

Furthermore, the network system 200 of the second embodiment is especially configured to include the plurality of remote control devices 4 and 5 to enable the individual setting of set data corresponding to each of the plurality of remote control devices 4 and 5 into each of the electronic devices 1 and 6. The electronic devices 1 and 6 can thereby be used on the basis of the different set data to each of the remote control devices 4 and 5, and the operationality of the electronic devices 1 and 6 can be improved. Moreover, the control based on the set data corresponding to the operated remote control device 4 or 5 is automatically performed, and then the operationality of the electronic devices 1 and 6 can further be improved. Furthermore, because the operation based on the set data associated with the remote control device 4 or 5 can be performed only when the corresponding remote control device 4 or 5 is used, security can be improved.

### (Configuration of Remote Control Device)

The network system 200 of the present second embodiment is provided with, for example, the two remote control devices 4 and 5. Each of these remote control devices 4 and 5 can cope with both of the first electronic device 1 and the second electronic device 6.

The key input section 41 equipped in each of the remote control devices 4 and 5 includes, for example, the set data transmission key 41b for transmitting the set data set in the first electronic device 1 or the second electronic device 6 to the server device 3, and a set data reception key 41c for transmitting a transmission request of the set data corresponding to the identification information of the remote control devices 4 and 5, which identification information is stored in the server device 3, to the server device 3. Moreover, one piece of identification information (for example, “001”) is assigned to the remote control device 4, and another piece of identification information (for example, “002”) is assigned to the remote control device 5.

### (Configuration of Second Electronic Device)

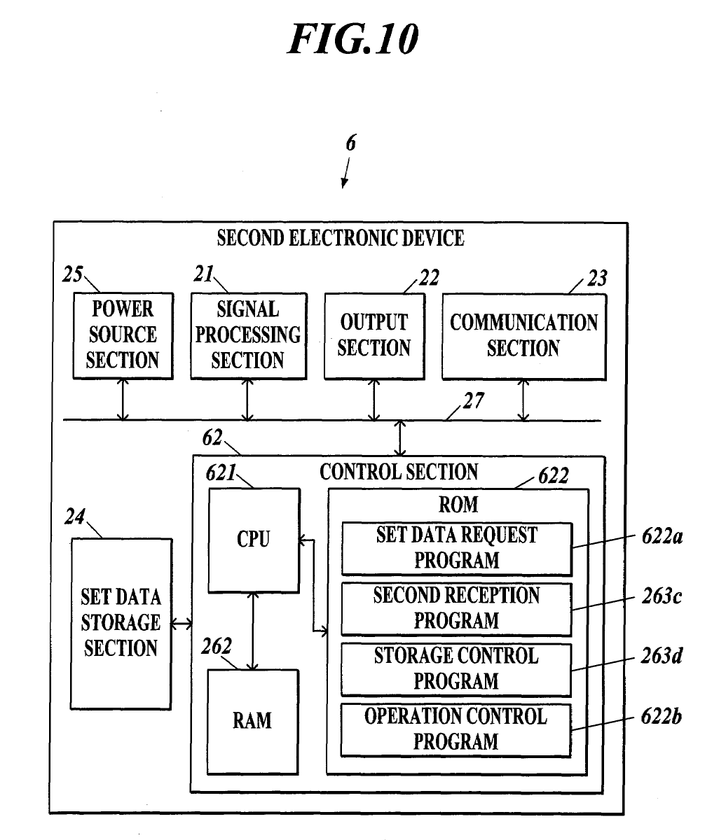

The second electronic device 6 is, for example, a television receiver, and is connected to the server device 3 through the network N, such as the Internet. FIG. 10 is a block diagram illustrating the configuration of the principal part of the second electronic device 6.

To put it concretely, the second electronic device 6 is, for example, as shown in FIG. 10, composed of the signal processing section 21 to perform various kinds of image and sound processing based on television broadcast signals, the output section 22 to output an image and a sound based on an image signal and sound signal, respectively, which are output from the signal processing section 21, the communication section 23 for performing the transmission and the reception of information with the server device 3 through the network N, the set data storage section 24 to store the set data of the second electronic device 6, the power source section 25 to perform the supply of electric power, and a control section 62. Each section is connected to one another through the bus 27.

The control section 62 is composed of, for example, a CPU 621, the RAM 262, and a ROM 622.

The CPU 621 executes various kinds of control processing in accordance with the processing programs stored in the ROM 622.

The ROM 622 stores the system program that can be executed in the second electronic device 6, the various processing programs that can be executed on the system program, the data to be used at the time of the execution of these various processing programs, the data of the processing results of arithmetic processing by the CPU 621, and the like. The programs are stored in the form of program codes that a computer can read.

To put it concretely, the ROM 622 stores, for example, a set data request program 622a, the second reception program 263c, the storage control program 263d, and an operation control program 622b.

The set data request program 622a is a program for enabling the CPU 621 to realize, for example, the function of associating a transmission request of the set data saved in the set data save table 32a of the server device 3 and the identification information assigned to the remote control device 4 or 5 with each other to transmit the associated set data and the identification information to the server device 3 through the network N, such as the Internet, in response to a key operation in the key input section 41 of the remote control device 4 or 5.

To put it concretely, for example, when a user performs a depression operation of the set data reception key 41c in the key input section 41 of the remote control device 4 or 5 and a remote control signal instructing the second electronic device 6 to receive the set data corresponding to the remote control device 4 or 5 is output to the CPU 621, the CPU 621 reads the identification information of the remote control device 4 or 5, which identification information is included in the remote control signal transmitted from the remote control device 4 or 5, respectively, and transmits a transmission request requesting the server device 3 to transmit the set data corresponding to the remote control device 4 or 5 among the pieces of set data saved in the set data save table 32a of the server device 3, and the identification information read from the remote control signal transmitted from the remote control device 4 or 5 to the server device 3 through the network N, such as the Internet, with the communication section 23 with the set data and the identification information associated with each other.

The CPU 621 functions as a set data request section by executing such set data request program 622a.

The operation control program 622b is a program for enabling the CPU 621 to realize, for example, the function of performing predetermined control on the basis of the set data corresponding to the identification information assigned to the remote control device 4 or 5 stored in the set data storage section 24, in response to a key operation of the key input section 41 in the remote control device 4 or 5.

To put it concretely, when a depression operation of a key in the key input section 41 of the remote control device 4 or 5 is performed and a remote control signal corresponding to the depressed key is output to the CPU 621, the CPU 621 extracts the identification information of the remote control device 4 or 5, which identification information is included in the remote control signal, and performs the control corresponding to the depressed key by referring to the set data corresponding to the identification information of the remote control device 4 or 5, which identification information is stored in the set data storage section 24. For example, when the remote control device 4 or 5 is operated and the remote control signal is transmitted to the CPU 621, the CPU 621 extracts the identification information (for example, “001” or “002”) included in the remote control signal, and reads the set data stored in association with the identification information from the set data storage section 24 to perform various kinds of control.

The CPU 621 functions as a control section by executing such operation control program 622b.

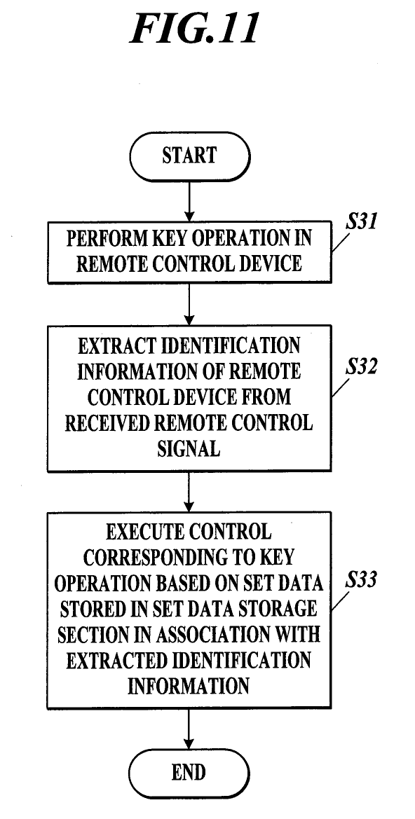

Next, the operation control processing executed by the CPU 621 of the second electronic device 6 is described with reference to the flow chart of FIG. 11.

The present operation control processing is performed by the execution of the operation control program 622b by the CPU 621 in the second electronic device 6.

Incidentally, the present operation control processing is the processing executed on the supposition that a plurality of pieces of set data is stored in the set data storage section 24 of the second electronic device 6 in the state of being associated with the plurality of pieces of identification information of the remote control devices 4 and 5, although the state is not shown, which plurality of pieces of set data is stored by the execution of the first transmission program 161a by the CPU 161 in the first electronic device 1, by the execution of the first reception program 333a, the save program 333b, the authentication program 333c, and the second transmission program 333d by the CPU 331 in the server device 3, and by the execution of the set data request program 622a, the second reception program 263c, and the storage control program 263d by the CPU 621 in the second electronic device 6.

First, at Step S31, when a user performs a depression operation of a key in the key input section 41 of the remote control device 4 or 5 and a remote control signal corresponding to the depressed key is output to the second electronic device 6, the CPU 621 of the second electronic device 6 extracts the identification information of the remote control device 4 or 5 that has transmitted the remote control signal from the received remote control signal at Step S32. Then, at Step S33, the CPU 621 reads the set data stored in the set data storage section 24 in the state of being associated with the extracted identification information, and executes the processing corresponding to the depressed key on the basis of the set data. Then, the CPU 261 ends the present processing.

According to the above-mentioned network system 200 in the second embodiment, to which the present invention is applied, one piece of the identification information is assigned to each of the plurality of remote control devices 4 and 5, and each of the plurality of remote control devices 4 and 5 is equipped with the key input section 41 for receiving a key operation by a user. In the first electronic device 1 and the second electronic device 6, by the set data storage sections 14 and 24, the pieces of set data pertaining to the setting of the electronic devices 1 and 6, respectively, are individually enabled to be stored by each of the pieces of identification information assigned to the remote control devices 4 and 5. In the first electronic device 1, the set data stored in the set data storage section 14 of the first electronic device 1 and the identification information assigned to the remote control device 4 or 5 are transmitted to the server device 3 through the network N with the set data and the identification information associated with each other on the basis of a key operation of the key input section 41 in the remote control device 4 or 5 by the execution of the first transmission program 163a by the CPU 161. In the server device 3, the set data and the identification information, which have been transmitted from the first electronic device 1 by the execution of the first transmission program 163a, are received by the execution of the first reception program 333a by the CPU 331, and the set data and the identification information, which have been received by the execution of the first reception program 333a, are saved in the set data save table 32a with the set data and the identification information associated with each other, by the execution of the save program 333b. Moreover, in the second electronic device 6, a transmission request of the set data saved by the execution of the save program 333b and the identification information assigned to the remote control device 4 or 5 are transmitted to the server device 3 through the network N with the transmission request and the identification information assigned with each other, on the basis of a key operation of the key input section 41 in the remote control device 4 or 5, by the execution of the set data request program 622a by the CPU 621. In the server device 3, the authentication of the identification information transmitted from the second electronic device 6 by the execution of the set data request program 622a is performed by judging whether the identification information corresponds to the identification information saved in the set data save table 32a or not by the execution of the authentication program 333c by the CPU 331, and the set data corresponding to the identification information authenticated by the execution of the authentication program 333c is extracted from the set data save table 32a to be transmitted to the second electronic device 6 by the execution of the second transmission program 333d. Furthermore, in the second electronic device 6, the set data transmitted from the server device 3 by the execution of the second transmission program 333d is received by the execution of the second reception program 263c by the CPU 621, and the set data received by the execution of the second reception program 263c is stored in the set data storage section 24 by the execution of the storage control program 263d. The predetermined control is then performed on the basis of the set data corresponding to the identification information assigned to the remote control device 4 or 5, which identification information is stored in the set data storage sections 14 and 24, in response to a key operation of the key input section 41 in the remote control device 4 or 5 by the execution of the operation control program 622b.

Consequently, because set data can be set in the second electronic device 6 only by downloading the set data of the first electronic device 1 from the server device 3 through the network N by the use of the remote control device 4 or 5, to which the same identification information as that of the remote control device 4 or 5 used at the time of transmitting the set data of the first electronic device 1 to the server device 3 is assigned, it becomes unnecessary to perform a setting operation from the beginning. Consequently, in the network system 200 in which the plurality of electronic devices 1 and 6 are connected to the network N, the operationality of the setting operation of the electronic device 6 can be improved.

Moreover, the electronic devices 1 and 6 are used on the basis of the set data of each of the remote control devices 4 and 5, and the control based on the set data corresponding to the operated remote control device 4 or 5 is automatically performed. Consequently, the operationality of the electronic devices 1 and 6 can be improved.

Furthermore, because the operation based on the set data associated with the used remote control device 4 or 5 can be performed only when the corresponding remote control device 4 or 5 is used, the improvement of security can be achieved.

Incidentally, various improvements and the changes of the design of the present invention may be performed without departing from the spirit of the invention.

For example, the number and the kinds of the electronic devices are not limited to those shown in the above embodiments. Moreover, for example, the network N may be a wireless network, such as the wireless local area network (LAN) in conformity with the Institute of Electrical and Electronic Engineers (IEEE) 802.11 standard, which can be realized in home or the like.

Moreover, although the description has been performed on the supposition that the network system 200 of the second embodiment is provided with two remote control devices 4 and 5, the number of the remote control devices is not limited to the two, but the number may be at least two.

Moreover, although the first embodiment and the second embodiment are designed so that, for example, when the set data transmission key 41b of the remote control device 4 or 5 is depressed, the set data of the first electronic device 1 is transmitted to the server device 3, the timing and the method of the transmission of the set data to the server device 3 are not limited to those of the embodiments, but they can be arbitrarily set. Moreover, although the second embodiment is similarly designed so that, when the set data reception key 41c of the remote control device 4 or 5 receives a depression operation, the transmission request of set data is transmitted to the server device 3, but the timing and the method of the transmission of the transmission request of set data to the server device 3 are not limited to those of the embodiment. For example, a configuration of selecting the set data corresponding to the remote control device to be used among a plurality of pieces of set data displayed on a menu screen may be adopted.

According to the embodiments of the present invention, there is provided a network system including: a first electronic device; a second electronic device; a server device connected to the first electronic device and the second electronic device through a network; and a remote control device, to which a piece of identification information is assigned, the remote control device including a key input section to receive a key operation by a user, wherein the first electronic device and the second electronic device severally include a set data storage section to store set data pertaining to setting of the first and second electronic devices, wherein the first electronic device includes a first transmission section to associate the set data stored in the set data storage section of the first electronic device and the identification information assigned to the remote control device and to transmit the associated set data and the identification information to the server device through the network on the basis of the key operation of the key input section in the remote control device; the server device includes: a first reception section to receive the set data and the identification information, which have been transmitted from the first electronic device by the first transmission section, and a save section to save the set data and the identification information, which have been received by the first reception section, the set data and the identification information being associated with each other; the second electronic device includes: a power source on/off section to control on and off of a power source of the second electronic device on the basis of the key operation of the key input section in the remote control device, and a set data request section to associate a transmission request of the set data saved by the save section and the identification information assigned to the remote control device with each other to transmit the associated transmission request and the set data to the server device through the network in response to turning-on of the power source by the power source on/off section; the server device includes: an authentication section to authenticate whether or not the identification information transmitted from the second electronic device by the set data request section corresponds to the identification information saved in the save section, and a second transmission section to extract the set data corresponding to the identification information authenticated by the authentication section from the save section to transmit the extracted set data to the second electronic device; and the second electronic device includes: a second reception section to receive the set data transmitted from the server device by the second transmission section, and a storage control section to allow the set data storage section to store the set data received by the second reception section, the storage control section deleting the set data stored by the set data storage section in response to turning-off of the power source by the power source on/off section.

By doing so, one piece of identification information is assigned to the remote control device, and the remote control device is provided with the key input section to receive a key operation by a user. In the first electronic device and the second electronic device, the set data storage sections store set data pertaining to the setting of the electronic devices, respectively. In the first electronic device, the set data stored in the set data storage section of the first electronic device and the identification information assigned to the remote control device are associated with each other, and the associated set data and the identification information are transmitted to the server device through the network by the first transmission section on the basis of a key operation of the key input section in the remote control device. In the server device, the set data and the identification information, which have been transmitted from the first electronic device, are received by the first transmission section by the first reception section, and the set data and the identification information, which have been received the first reception section, are saved with the set data and the identification information associated with each other by the save section. Moreover, in the second electronic device, the power source thereof is turned on or off on the basis of a key operation of the key input section in the remote control device by the power source on/off section, and a transmission request of the set data saved by the save section and the identification information assigned to the remote control device are associated with each other and are transmitted to the server device through the network by the set data request section in response to the turning-on of the power source of the second electronic device by the power source on/off section. In the server device, the authentication of the identification information transmitted from the second electronic device by the set data request section is performed by judging whether the identification information corresponds to the identification information saved in the save section or not by the authentication section, and the set data corresponding to the identification information authenticated by the authentication section is extracted from the save section and is transmitted to the second electronic device by the second transmission section. Furthermore, in the second electronic device, the set data transmitted from the server device is received by the second transmission section, and the set data received by the second reception section is stored in the set data storage section and the set data stored in the set data storage section is deleted in response to the turn-off of the power source by the power source on/off section by the execution of the set data storage section.

Consequently, because set data is set in the second electronic device only by downloading the set data of the first electronic device from the server device through the network by the use of the remote control device, to which the same identification information as that of the remote control device used at the time of the transmission of the set data of the first electronic device to the server device is assigned, it becomes unnecessary to perform a setting operation from the beginning. Consequently, in the network system, in which the plurality of electronic devices is connected to the network, the operationality in the setting operation of the electronic device can be improved.

Moreover, the second electronic device is designed so that, when the power source of the second electronic device is turned on by the remote control device, to which a piece of identification information is assigned, the set data corresponding to the remote control device is automatically set in the second electronic device. Consequently, the performance of any special operations for setting the set data becomes unnecessary, and desired set data can be set only by using the correspond remote control device. Hence, the operationality can furthermore be improved. Moreover, the second electronic device is designed so that, when the power source thereof is turned off by the one remote control device, the set data set in the second electronic device is automatically deleted. Consequently, it can be prevented that the set data is illegally used or changed by a third person.

According to the embodiments of the present invention, there is provided a network system including: a first electronic device; a second electronic device; a server device connected to the first electronic device and the second electronic device through a network; and a remote control device, to which a piece of identification information is assigned, the remote control device including a key input section to receive a key operation by a user, wherein the first electronic device and the second electronic device severally include a set data storage section to store set data pertaining to setting of the first and second electronic devices, wherein the first electronic device includes a first transmission section to associate the set data stored in the set data storage section of the first electronic device and the identification information assigned to the remote control device and to transmit the associated set data and the identification information to the server device through the network on the basis of the key operation of the key input section in the remote control device; the server device includes: a first reception section to receive the set data and the identification information, which have been transmitted from the first electronic device by the first transmission section, and a save section to save the set data and the identification information, which have been received by the first reception section, the set data and the identification information being associated with each other; the second electronic device includes a set data request section to associate a transmission request of the set data saved by the save section and the identification information assigned to the remote control device with each other to transmit the associated transmission request and the set data to the server device through the network on the basis of the key operation of the key input section in the remote control device; the server device includes: an authentication section to authenticate whether or not the identification information transmitted from the second electronic device by the set data request section corresponds to the identification information saved in the save section, and a second transmission section to extract the set data corresponding to the identification information authenticated by the authentication section from the save section to transmit the extracted set data to the second electronic device; and the second electronic device includes: a second reception section to receive the set data transmitted from the server device by the second transmission section, and a storage control section to allow the set data storage section to store the set data received by the second reception section.

By doing so, one piece of identification information is assigned to the remote control device, and the remote control device is provided with the key input section to receive a key operation by a user. In the first electronic device and the second electronic device, the set data storage sections store set data pertaining to the setting of the electronic devices, respectively. In the first electronic device, the set data stored in the set data storage section of the first electronic device and the identification information assigned to the remote control device are associated with each other, and the associated set data and the identification information are transmitted to the server device through the network by the first transmission section on the basis of a key operation of the key input section in the remote control device. In the server device, the set data and the identification information, which have been transmitted from the first electronic device, are received by the first transmission section by the first reception section, and the set data and the identification information, which have been received the first reception section, are saved with the set data and the identification information associated with each other by the save section. Moreover, in the second electronic device, on the basis of a key operation of the key input section in the remote control device, by the set data request section, and a transmission request of the set data saved by the save section and the identification information assigned to the remote control device are associated with each other and are transmitted to the server device through the network by the set data request section in response to the turning-on of the power source of the second electronic device by the power source on/off section. In the server device, the authentication of the identification information transmitted from the second electronic device by the set data request section is performed by judging whether the identification information corresponds to the identification information saved in the save section or not by the authentication section, and the set data corresponding to the identification information authenticated by the authentication section is extracted from the save section and is transmitted to the second electronic device by the second transmission section. Furthermore, in the second electronic device, the set data transmitted from the server device is received by the second transmission section, and the set data received by the second reception section is stored in the set data storage section.

Consequently, because set data is set in the second electronic device only by downloading the set data of the first electronic device from the server device through the network by the use of the remote control device, to which the same identification information as that of the remote control device used at the time of the transmission of the set data of the first electronic device to the server device is assigned, it becomes unnecessary to perform a setting operation from the beginning. Consequently, in the network system, in which the plurality of electronic devices is connected to the network, the operationality in the setting operation of the electronic device can be improved.

According to the embodiments of the present invention, there is provided a network system including: a first electronic device; a second electronic device; a server device connected to the first electronic device and the second electronic device through a network; and a plurality of remote control devices, to each of which a piece of identification information is assigned, each of the remote control devices including a key input section to receive a key operation by a user, wherein the first electronic device and the second electronic device severally include a set data storage section capable of individually storing set data pertaining to setting of the first and second electronic devices by the identification information assigned to each of the remote control devices, wherein the first electronic device includes a first transmission section to associate the set data stored in the set data storage section of the first electronic device and the identification information assigned to the remote control device and to transmit the associated set data and the identification information to the server device through the network on the basis of the key operation of the key input section in one of the remote control device; the server device includes: a first reception section to receive the set data and the identification information, which have been transmitted from the first electronic device by the first transmission section, and a save section to save the set data and the identification information, which have been received by the first reception section, the set data and the identification information being associated with each other; the second electronic device includes a set data request section to associate a transmission request of the set data saved by the save section and the identification information assigned to the remote control device with each other to transmit the associated transmission request and the set data to the server device through the network on the basis of the key operation of the key input section in the remote control device; the server device includes: an authentication section to authenticate whether or not the identification information transmitted from the second electronic device by the set data request section corresponds to the identification information saved in the save section, and a second transmission section to extract the set data corresponding to the identification information authenticated by the authentication section from the save section to transmit the extracted set data to the second electronic device; and the second electronic device includes: a second reception section to receive the set data transmitted from the server device by the second transmission section, a storage control section to allow the set data storage section to store the set data received by the second reception section, and a control section to perform predetermined control on the basis of the set data corresponding to the identification information assigned to the remote control device stored in the set data storage section in response to the key operation of the key input section in the remote control device.

By doing so, each of the plurality of remote control devices is assigned the one piece of identification information, and includes the key input section to receive the key operation by the user. In the first electronic device and the second electronic device, the set data storage sections enable the individual storage of the set data pertaining to the setting of the electronic devices by the identification information assigned to each of the remote control devices. In the first electronic device, the first transmission section associates the set data stored in the set data storage section of the first electronic device and the identification information assigned to the remote control device, and transmits the associated set data and the identification information to the server device through the network on the basis of the key operation of the key input section in the remote control device. In the server device, the first reception section receives the set data and the identification information, which have been transmitted from the first electronic device by the first transmission section, and the save section saves the set data and the identification information, which have been received by the first reception section, with the set data and the identification information associated with each other. Moreover, in the second electronic device, the set data request section associates the transmission request of the set data saved by the save section and the identification information assigned to the remote control device with each other to transmit the associated transmission request and the set data to the server device through the network on the basis of the key operation of the key input section in the remote control device. In the server device, the authentication section performs the authentication of the identification information transmitted from the second electronic device by the set data request section by judging whether the identification information corresponds to the identification information saved in the save section or not, and the second transmission section extracts the set data corresponding to the identification information authenticated by the authentication section from the save section to transmit the extracted set data to the second electronic device. Furthermore, in the second electronic device, the second reception section receives the set data transmitted from the server device by the second transmission section; the storage control section makes the set data storage section store the set data received by the second reception section; and the control section performs the predetermined control on the basis of the set data corresponding to the identification information assigned to the remote control device, which set data is stored in the set data storage section, in response to the key operation of the key input section in the remote control device.

Consequently, in the second electronic device, the set data is set only by downloading the set data of the first electronic device from the server device through the network by the use of the remote control device assigned the same identification information as that of the remote control device used at the time of transmitting the set data of the first electronic device to the server device. Hence, it becomes unnecessary to perform the setting operation from the beginning. Consequently, in the network system in which a plurality of electronic devices is connected to the network, the operationality of the setting operation of an electronic device can be improved.

Moreover, the electronic device is used on the basis of the set data to each remote control device, and the control based on the set data corresponding to the operated remote control device is automatically performed. Thus, the operationality of the electronic device can be improved.

Furthermore, because the operation based on the set data associated to the remote control device can be performed only when the corresponding remote control device is used, the improvement of security can be achieved.

The entire disclosure of Japanese Patent Application No. 2006-307626 filed on Nov. 14, 2006 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A network system comprising:
a first electronic device;
a second electronic device;
a server device connected to the first electronic device and the second electronic device through a network; and
a remote control device, to which a piece of identification information is assigned, the remote control device including a key input section to receive a key operation by a user, wherein
the first electronic device and the second electronic device severally include a set data storage section to store set data pertaining to setting of the first and second electronic devices, wherein
the first electronic device includes a first transmission section to associate the set data stored in the set data storage section of the first electronic device and the identification information assigned to the remote control device and to transmit the associated set data and the identification information to the server device through the network on the basis of the key operation of the key input section in the remote control device;
the server device includes:
a first reception section to receive the set data and the identification information, which have been transmitted from the first electronic device by the first transmission section, and
a save section to save the set data and the identification information, which have been received by the first reception section, the set data and the identification information being associated with each other;
the second electronic device includes:
a power source on/off section to control on and off of a power source of the second electronic device on the basis of the key operation of the key input section in the remote control device, and
a set data request section to associate a transmission request of the set data saved by the save section and the identification information assigned to the remote control device with each other to transmit the associated transmission request and the set data to the server device through the network in response to turning-on of the power source by the power source on/off section;
the server device includes:
an authentication section to authenticate whether or not the identification information transmitted from the second electronic device by the set data request section corresponds to the identification information saved in the save section, and
a second transmission section to extract the set data corresponding to the identification information authenticated by the authentication section from the save section to transmit the extracted set data to the second electronic device; and
the second electronic device includes:
a second reception section to receive the set data transmitted from the server device by the second transmission section, and
a storage control section to allow the set data storage section to store the set data received by the second reception section, the storage control section deleting the set data stored by the set data storage section in response to turning-off of the power source by the power source on/off section.

2. A network system comprising:
a first electronic device;
a second electronic device;
a server device connected to the first electronic device and the second electronic device through a network; and
a remote control device, to which a piece of identification information is assigned, the remote control device including a key input section to receive a key operation by a user, wherein
the first electronic device and the second electronic device severally include a set data storage section to store set data pertaining to setting of the first and second electronic devices, wherein
the first electronic device includes a first transmission section to associate the set data stored in the set data storage section of the first electronic device and the identification information assigned to the remote control device and to transmit the associated set data and the identification information to the server device through the network on the basis of the key operation of the key input section in the remote control device;
the server device includes:
a first reception section to receive the set data and the identification information, which have been transmitted from the first electronic device by the first transmission section, and
a save section to save the set data and the identification information, which have been received by the first reception section, the set data and the identification information being associated with each other;
the second electronic device includes a set data request section to associate a transmission request of the set data saved by the save section and the identification information assigned to the remote control device with each other to transmit the associated transmission request and the set data to the server device through the network on the basis of the key operation of the key input section in the remote control device;
the server device includes:
an authentication section to authenticate whether or not the identification information transmitted from the second electronic device by the set data request section corresponds to the identification information saved in the save section, and
a second transmission section to extract the set data corresponding to the identification information authenticated by the authentication section from the save section to transmit the extracted set data to the second electronic device; and
the second electronic device includes:
a second reception section to receive the set data transmitted from the server device by the second transmission section, and
a storage control section to allow the set data storage section to store the set data received by the second reception section.

3. A network system comprising:
a first electronic device;
a second electronic device;
a server device connected to the first electronic device and the second electronic device through a network; and
a plurality of remote control devices, to each of which a piece of identification information is assigned, each of the remote control devices including a key input section to receive a key operation by a user, wherein
the first electronic device and the second electronic device severally include a set data storage section capable of individually storing set data pertaining to setting of the first and second electronic devices by the identification information assigned to each of the remote control devices, wherein
the first electronic device includes a first transmission section to associate the set data stored in the set data storage section of the first electronic device and the identification information assigned to the remote control device and to transmit the associated set data and the identification information to the server device through the network on the basis of the key operation of the key input section in one of the remote control device;
the server device includes:
a first reception section to receive the set data and the identification information, which have been transmitted from the first electronic device by the first transmission section, and
a save section to save the set data and the identification information, which have been received by the first reception section, the set data and the identification information being associated with each other;
the second electronic device includes a set data request section to associate a transmission request of the set data saved by the save section and the identification information assigned to the remote control device with each other to transmit the associated transmission request and the set data to the server device through the network on the basis of the key operation of the key input section in the remote control device;
the server device includes:
an authentication section to authenticate whether or not the identification information transmitted from the second electronic device by the set data request section corresponds to the identification information saved in the save section, and
a second transmission section to extract the set data corresponding to the identification information authenticated by the authentication section from the save section to transmit the extracted set data to the second electronic device; and
the second electronic device includes:
a second reception section to receive the set data transmitted from the server device by the second transmission section,
a storage control section to allow the set data storage section to store the set data received by the second reception section, and
a control section to perform predetermined control on the basis of the set data corresponding to the identification information assigned to the remote control device stored in the set data storage section in response to the key operation of the key input section in the remote control device.
